(19) United States
(12) Patent Application Publication
(10) Pub. No.: US 2002/0070650 A1
(43) Pub. Date: Jun. 13, 2002

(54) Lamp apparatus for liquid crystal display

(76) Inventors: Kyoung Sub Kim, Kumi-shi (KR); Yun Ho Hwang, Kumi-shi (KR)

Correspondence Address: LONG ALDRIDGE & NORMAN, LLP, 701 PENNSYLVANIA AVENUE N.W., SUITE 600, WASHINGTON, DC, 20004, US

(21) Appl. No.: 09/891,284

(22) Filed: Jun. 27, 2001

(30) Foreign Application Priority Data
Dec. 11, 2000 (KR) 2000-75159

(51) Int. Cl. H01J 5/48

(52) U.S. Cl. 313/318.01

(57) ABSTRACT

A lamp apparatus for a liquid crystal display that is capable of preventing a short and a breakage of the lamp apparatus. In the lamp apparatus, a lamp generates light, and a wire supplies external electric power to the lamp. A soldering connects the lamp to the wire. A holder encloses the soldering and a lamp housing encloses the holder and the lamp. A resin in the holder seals a space between the soldering and the holder.

This application claims the benefit of Korean Patent Application No. P00-75159 filed on Dec. 11, 2000 which is hereby incorporated by reference as if fully set forth herein.

### BACKGROUND OF THE INVENTION

1. Field of the Invention

This invention relates to a liquid crystal display, and more particularly to a lamp apparatus for a liquid crystal display that is capable of preventing wire short circuiting and breakage of the lamp apparatus.

2. Discussion of the Related Art

Generally, active matrix liquid crystal display devices (LCD) use thin film transistors (TFTs) as switching devices to display moving pictures. Because LCDs are able to provide a product having a smaller dimension than a cathode ray tube (CRT), they have been widely used in various applications such as personal computers, notebook computers, office automation equipment such as a copy machines, etc., and portable equipment such as a cellular phones and pagers, etc.

Such an LCD has a lower substrate provided with switching devices, including TFTs, consisting of gate electrodes, a gate insulating film, an active layer, an ohmic contact layer, source and drain electrodes and pixel electrodes, and an upper substrate provided with color filters. A liquid crystal is injected between the upper substrate and the lower substrate and an electric field is applied to the liquid crystal to control a light transmissivity, thereby displaying a picture. This LCD requires a backlight unit because it is not a self-luminescent display device.

The backlight unit includes a lamp emitting a light by a discharge; a light guide for guiding light from the lamp into an LCD panel; an optical sheet attached to the light guide; a reflector enclosing side and bottom surfaces of the light guide; and a lamp housing enclosing the lamp.

A lamp electrode is usually connected to a wire by a soldering technique. If the lamp electrode is connected to the wire by a soldering technique however, the connection between the lamp electrode and the wire electrode is easily broken due to movement of the wire during fabrication or upon usage.

Referring to FIG. 1, the conventional LCD module includes an LCD module case 20 provided with an LCD panel 22 having TFTs, and a lamp apparatus 24 installed at each side of the LCD module case 20 to emit a light onto the LCD panel 22. The LCD module case 20 encloses the periphery of the lamp apparatus 24. A light guide (not shown) is provided to guide a light from the lamp apparatus 24 into the LCD panel 22. The LCD module case 20 is made from a metal.

FIG. 2 and FIG. 3 shows the lamp apparatus 24 for generating a light at the LCD panel 22. FIG. 3 shows an enlargement of portion A of FIG. 2.

Referring to FIG. 2 and FIG. 3, the conventional lamp apparatus for the LCD includes a lamp 2 for generating light, a wire 3 for applying an external electric power to the lamp 2, a soldering 4 for electrically connecting the lamp 2 to the wire 3, a holder 5 for enclosing the lamp 2, the wire 3 and the soldering 4, and a lamp housing 1 into which the holder 5 is introduced.

A portion of the end of the lamp 2 encloses the holder 5. Also, the lamp 2 passes through the lamp housing 1. Such a lamp 2 is positioned at one side of a backlight-supporting member in the lamp housing 1. The lamp 2 is connected to the wire 3 to supply external electric power. The wire 3 is provided such that a cable connected to the external and internal power sources pass through the holder 5 so as to apply external electric power to the lamp 2. The holder 5 passes through the lamp housing 1. The holder 5 is responsible for enclosing the lamp 2, the wire 3 and the soldering 4. The lamp housing 1 positions the lamp 2 at one side thereof and encloses the holder 5.

In such a conventional lamp apparatus, an electrode of the lamp 2 is electrically connected to an electrode of the wire 3 by the soldering 4 to supply the external electric power. The conventional lamp apparatus has a problem in that, since an electrical connection between the lamp 2 and the wire 3 employing the soldering 4 is made in parallel by a solder, air bubbles are formed in the cold soldering causing a poor connection.

Such a poor connection of the wire 3 is liable to cause a short and breakage of the wire 3 at the soldering portion 4 when an external force, such as a physical removal from the exterior, is applied thereto. Also, tension testing of the soldering portion 4 causes shorting and breakage of the connection, as shown in FIG. 4.

Referring to FIG. 4, a wire breakage 26 is generated when the end of the lamp housing 1 comes into contact with the wire 3. Also, when the end of the lamp housing 1 contacts the wire 3, a wire short 26 occurs due to a damage of a coated wire, such as a stripped coating. In order to prevent such wire short and breakage, a lamp apparatus as shown in FIG. 5 has been provided.

Referring to FIG. 5 and FIG. 6, the conventional lamp apparatus includes a lamp housing 11 into which a lamp (not shown) is inserted, a wire 12 for supplying external electric power to the lamp, and a heat-contractible tube 13 inserted into the end of the lamp housing 11 to enclose the wire 12. The lamp receives external electric power applied over the wire 12 to generate light. The wire 12 passes through the end of the lamp housing 11 to apply external electric power to the lamp.

The heat-contractible tube 13 keeps the end of the lamp housing 11 and the wire 12 at a desired height. Also, the heat-contractible tube 13 is responsible for enclosing the wire 12. Alternatively, the end of the lamp housing 11 and the wire 12 may be kept at a desired height by a tape adhesive (not shown) instead of the heat-contractible tube 13.

The wire 12 may be in a direct contact with the end of the lamp housing 11 to damage its coating. Thus, the wire 12 is liable to be shorted or broken. The short and breakage caused by such a coating damage raises a problem in that the external electric power fails to be supplied to the lamp 12.

An installed position of the heat-contractible tube 13 or the tape adhesive is very important. An installation of the heat-contractible tube 13 and the tape adhesive has a drawback in that, since the installation is done by hand, it is very difficult to keep the end of the lamp housing 11 and the wire at a desired height and to protect the wire 12. Also, the cost of the lamp apparatus is increased because of the hand installation.

As described above, in the conventional lamp apparatus, a poor connection between the power wire and the lamp is caused by air bubbles in the solder. In addition, the wire comes into contact with the end of the lamp housing by an external force transferred to the soldering portion and causes a short or break in the wire. As a result, the conventional lamp apparatus for the LCD has a problem in that an electric power is not supplied to the lamp because of a short or a breakage of the wire.

### SUMMARY OF THE INVENTION

Accordingly, the present invention is directed to a lamp apparatus for a liquid crystal display device that substantially obviates one or more of the problems due to the limitations and disadvantages of the related art.

An object of the present invention is to provide a lamp apparatus for a liquid crystal display device that is capable of preventing a short and a breakage of the lamp apparatus.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In order to achieve these and other objects of the invention, a lamp apparatus for a liquid crystal display according to one embodiment of the present invention includes a lamp for generating a light; a wire for supplying external electric power to the lamp; a soldering for connecting the lamp to the wire; a holder for enclosing the soldering; a lamp housing for enclosing the holder and the lamp; and a resin filled in the holder to seal a space between the soldering and the holder.

The resin is selected from any one of silicon, ultraviolet-cured resin and epoxy resin. The lamp apparatus further includes a liquid crystal display module case provided with the lamp apparatus for the liquid crystal display.

A lamp apparatus for a liquid crystal display according to another embodiment of the present invention includes a lamp for generating a light; a wire for supplying external electric power to the lamp; a lamp housing for enclosing the lamp and the wire; and a resin provided at the end of the lamp housing in such a manner to enclose the wire at the end of the lamp housing.

The lamp apparatus further includes a soldering for electrically connecting the lamp to the wire; a holder passing through the lamp housing to enclose the lamp, the wire and the soldering, and a liquid crystal display module case provided with the lamp apparatus for the liquid crystal display.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a plan view showing a structure of a typical liquid crystal display module;

FIG. 2 is a sectional view showing a structure of the conventional lamp apparatus in FIG. 1;

FIG. 3 is an enlarged sectional view of the portion A of FIG. 2;

FIG. 4 is a sectional view of a breakage occurring at the portion B of FIG. 3;

FIG. 5 is a sectional view showing a structure of the conventional lamp apparatus in FIG. 1;

FIG. 6 is an enlarged sectional view of the portion C of FIG. 5;

FIG. 7 is a sectional view showing a structure of a lamp apparatus for a liquid crystal display according to a first embodiment of the present invention;

FIG. 8 is an enlarged section view of the portion D of FIG. 7;

FIG. 9 illustrates a state in which a resin has been coated at the portion E of FIG. 8;

FIG. 10 is a sectional view showing a structure of a lamp apparatus for a liquid crystal display according to a second embodiment of the present invention;

FIG. 11 is an enlarged sectional view of the portion “F” of FIG. 10; and

FIG. 12 is a detailed side view of the portion “F” shown in FIG. 11.

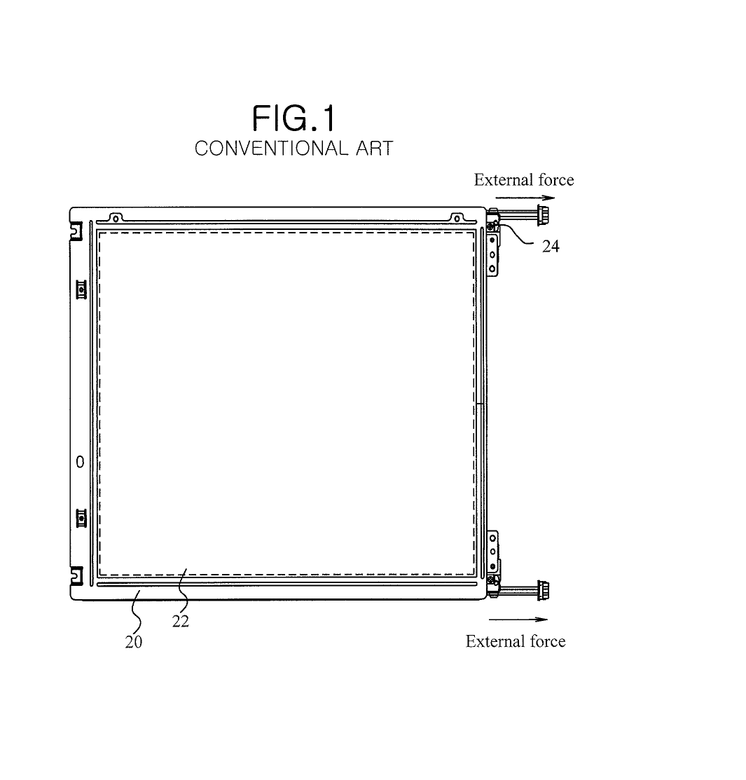

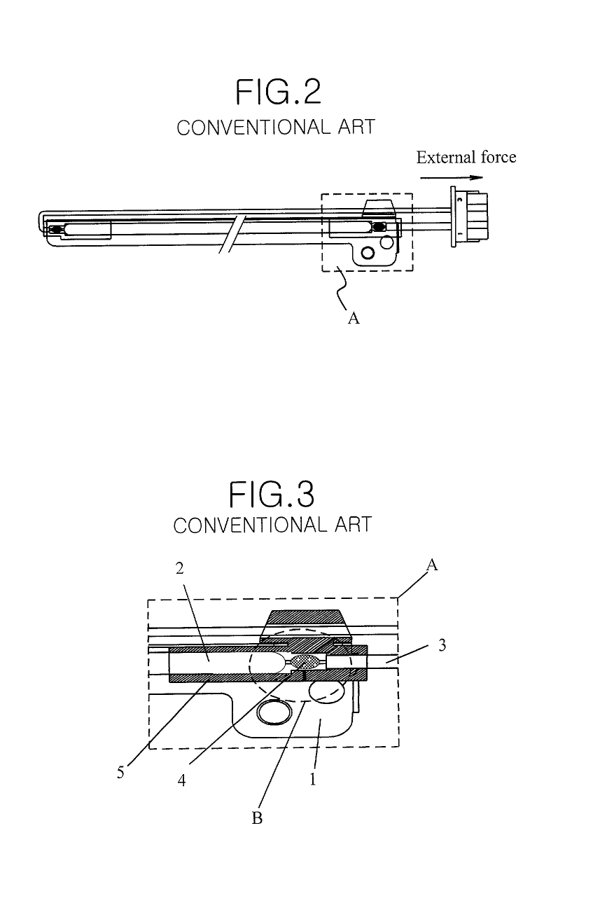

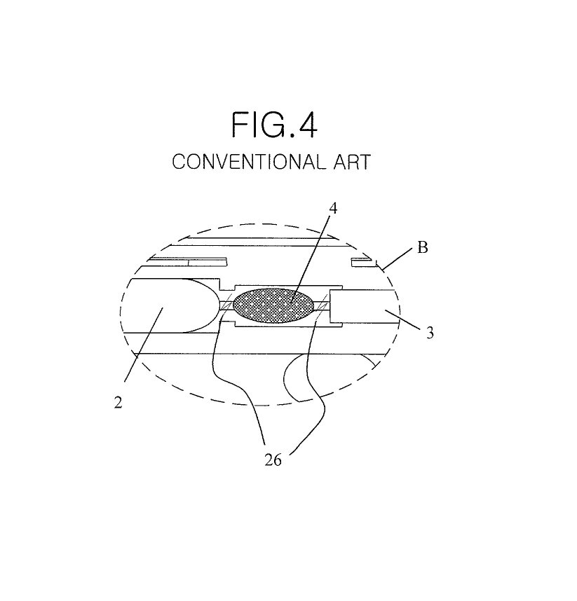

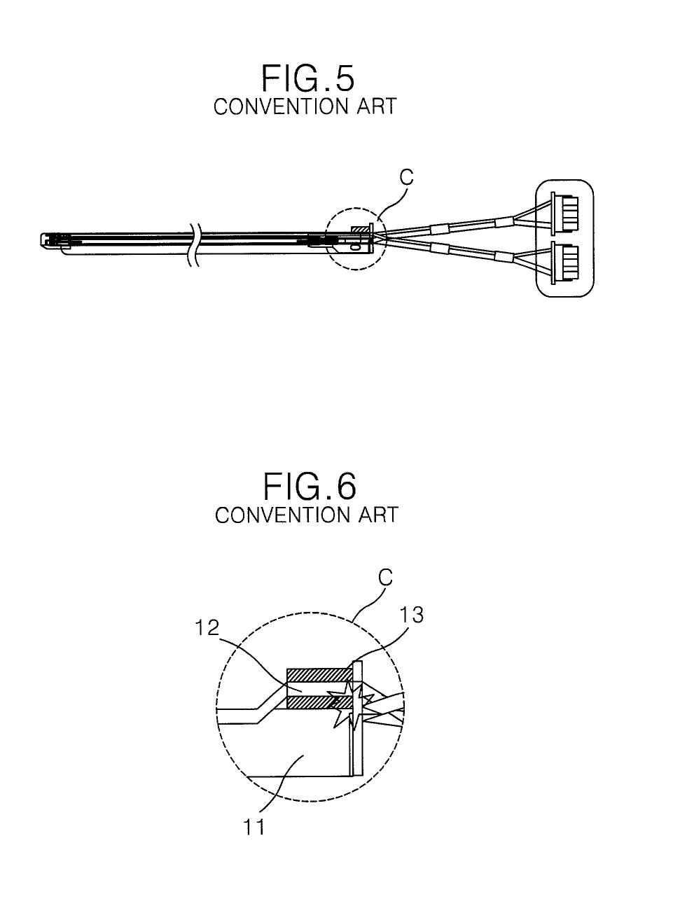

### DETAILED DESCRIPTION OF THE PREFERRED EMBODIMENTS

Reference will now be made in detail to the preferred embodiment of the present invention, examples of which are illustrated in the accompanying drawings.

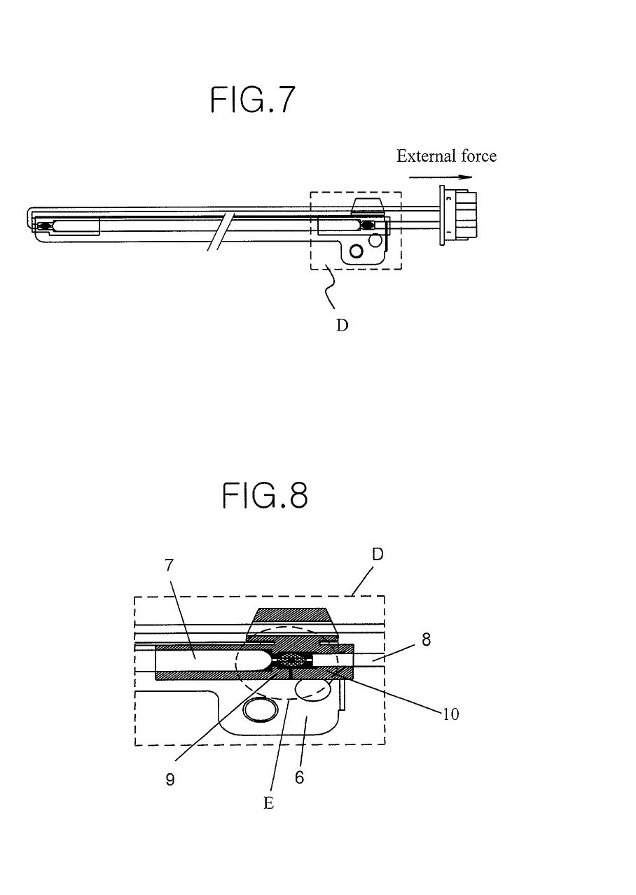

Referring to FIG. 7 and FIG. 8, there is shown a lamp apparatus for a liquid crystal display according to a first embodiment of the present invention. The lamp apparatus includes a lamp 7 for generating light; a wire 8 for applying external electric power to the lamp 7; a soldering 9 for electrically connecting the lamp 7 to the wire 8; a holder 10 for enclosing the lamp 7, the wire 8 and the soldering 9; and a lamp housing 6 into which the holder 10 is introduced.

A portion of the end of the lamp 7 is enclosed by the holder 10. Also, the lamp 7 passes through the lamp housing 6. Such a lamp 7 is positioned at one side of a backlight-supporting member in the lamp housing 6. The lamp 7 is connected to the wire 8 to supply external electric power. The wire 8 is provided such that a cable connected to the external and internal power sources pass through the holder 10 to apply external electric power to the lamp 7. The holder 10 passes through the lamp housing 6. The holder 10 is responsible for enclosing the lamp 7, the wire 8 and the soldering 9. The lamp housing 6 positions the lamp 7 at one side thereof and encloses the holder 10.

In such a lamp apparatus, the lamp 7 is supplied with electric power over the wire 8, which is connected to an external power source via a through path defined at the inside of the holder 10. To this end, an electrode of the lamp 7 is connected to an electrode of the wire 8 by the soldering 9.

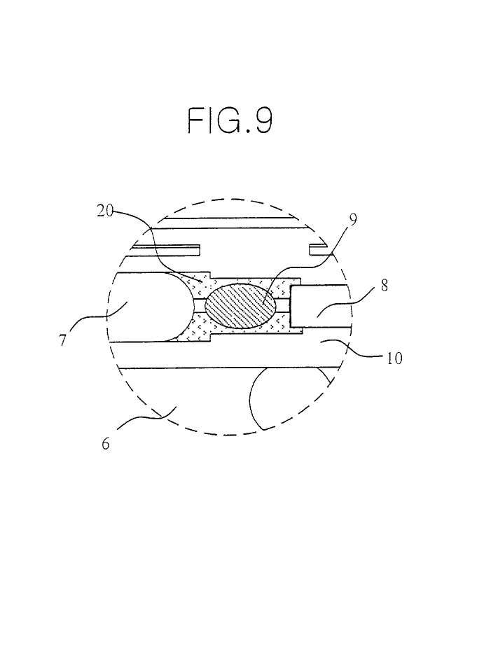

The soldering 9, which connects to the electrode of the lamp 7 and the electrode of the wire 8, is very susceptible to external force, such as a physical removal. Such force can thus cause a break or short in conventional devices. In order to prevent such short and breakage of the wire, as shown in FIG. 9, the soldering 9 and an inner portion of the holder 10 are coated with a resin.

Referring to FIG. 9, a resin coating is applied aroung the ends of the lamp 7 and the wire 8 and the front side of the soldering 9. The resin 20 is then cured. The resin 20 used for a resin coating is selected from silicon, ultraviolet-cured resin and epoxy resin, etc.

An external force, such as that caused by physical removal of the lamp apparatus is not transferred to the soldering 9 because of application of the resin 20 around the soldering 9 and curing of the resin 20, as mentioned above. The cured resin 20 protects a short and a breakage of the wire 8. Also, external force is not transferred to the soldering 9 in a tension test to exert a sufficient tensile force that might cause a short or break in the wire 8.

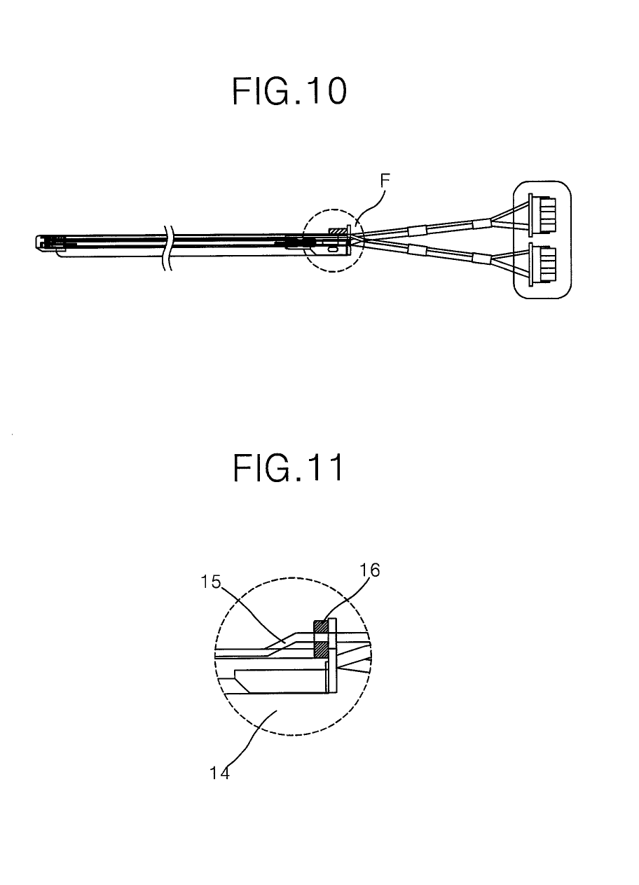

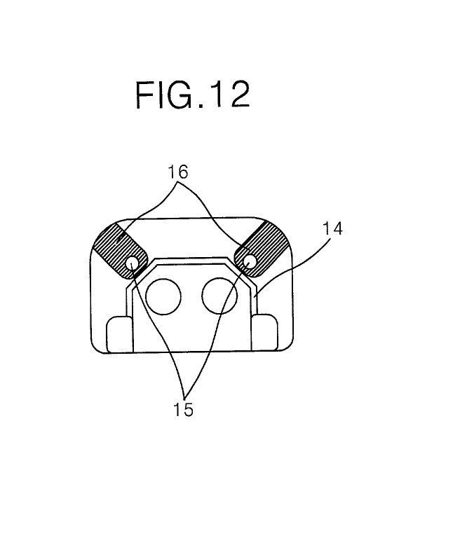

Referring to FIG. 10, there is shown a lamp apparatus for a liquid crystal display according to a second embodiment of the present invention. As shown in FIG. 10 to FIG. 12, the lamp apparatus includes a lamp housing 14 into which a lamp (not shown) is inserted, a wire 15 for supplying external electric power to the lamp, and a resin 16 provided at the end of the lamp housing 14 to enclose the wire 15. The lamp receives external electric power supplied over the wire 15 to generate light. The wire 15 passes through the end of the lamp housing 14 to apply external electric power to the lamp. The resin 16 is injected between the end of the lamp housing 14 and the wire 15. (A resin used for) the resin 16 is selected from silicon, ultraviolet-cured resin and epoxy resin, etc.

Accordingly, the resin 16 keeps the end of the lamp housing 14 and the wire 15 at a desired height and prevents the end of the lamp housing 14 from being in a direct contact with the wire 15, thereby preventing a short and a breakage of the wire 15. Such a resin 16 can solve problems of hand installation of the heat-contractible tube and the associated increased cost of the lamp apparatus. Also, a member for preventing a direct contact between the end of the lamp housing 14 and the wire 15, such as a tape adhesive, is not required.

Alternatively, the lamp apparatus according to the first and second embodiments of the present invention may be installed at one side or both sides of the LCD module case 20.

As described above, according to the present invention, the inner portion between the soldering and the lamp holder is filled and coated with a resin such as silicon, ultraviolet-cured resin and epoxy resin, etc., so that external force can be absorbed-by the resinous coated material and thus prevent transfer of the force into the soldering to prevent a wire short. Therefore, an additional device for preventing external force from being transferred to the soldering portion is not required to permit a slim-type design. Furthermore, the resin is provided at the end of the lamp housing, so that it becomes possible to protect the wire, as well as to prevent a short and a breakage of the wire caused by damage to the wire coating.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. For instance, it should be understood that the present liquid crystal display device is widely applicable to display devices for military equipment and car navigation and other various display devices besides a display device for aircraft. Accordingly, the scope of the invention shall be determined only by the appended claims and their equivalents.

What is claimed is:

1. A lamp apparatus for a liquid crystal display, comprising:
a lamp for generating light;
a wire for supplying external electric power to the lamp;
a soldering for connecting the lamp to the wire;
a holder for enclosing the soldering;
a lamp housing for enclosing the holder and the lamp; and
a resin in the holder between the soldering and the holder.

2. The lamp apparatus according to claim 1, wherein the resin is selected from any one of silicon, ultraviolet-cured resin and epoxy resin.

3. A liquid crystal display module, comprising:
a liquid crystal display module case provided with a lamp apparatus, the lamp apparatus including:
a lamp for generating light;
a wire for supplying external electric power to the lamp;
a soldering for connecting the lamp to the wire;
a holder for enclosing the soldering;
a lamp housing for enclosing the holder and the lamp; and
a resin in the holder between the soldering and the holder.

4. The lamp apparatus according to claim 3, wherein said lamp apparatus is installed at each side of the liquid crystal display module case.

5. A lamp apparatus for a liquid crystal display, comprising:
a lamp for generating light;
a wire for supplying external electric power to the lamp;
a lamp housing for enclosing the lamp and the wire; and
a resin provided at an end of the lamp housing in such a manner to enclose the wire a the end of the lamp housing.

6. The lamp apparatus according to claim 5, further comprising:
a soldering for electrically connecting the lamp to the wire; and
a holder passing through the lamp housing to enclose the lamp, the wire and the soldering.

7. The lamp apparatus according to claim 5, wherein the resin is selected from any one of silicon, ultraviolet-cured resin and epoxy resin.

8. A liquid crystal display module, comprising:
a liquid crystal display module case provided with a lamp apparatus, the lamp apparatus including:
a lamp for generating light;
a wire for supplying external electric power to the lamp;
a lamp housing for enclosing the lamp and the wire; and
a resin provided at an end of the lamp housing in such a manner to enclose the wire at the end of the lamp housing.

9. The lamp apparatus according to claim 8, wherein said lamp apparatus is installed at each side of the liquid crystal display module case.

10. A lamp apparatus for a liquid crystal display, comprising:
a lamp;
a wire connecting the lamp to an external power supply;
a lamp housing enclosing the holder and the lamp; and
a resin between around an end of the wire

11. The lamp apparatus of claim 10, wherein the wire is connected to the lamp by solder.

12. The lamp apparatus of claim 11, further comprising a holder around the solder, wherein the resin is positioned between the solder and the holder.

13. The lamp apparatus of claim 10, wherein the resin is selected from a group consisting of silicon, ultra-violet cured resin and epoxy resin.
